(19) United States
(12) Patent Application Publication
(10) Pub. No.: US 2022/0277761 A1
(43) Pub. Date: Sep. 1, 2022

(54) IMPRESSION ESTIMATION APPARATUS, LEARNING APPARATUS, METHODS AND PROGRAMS FOR THE SAME

(71) Applicant: NIPPON TELEGRAPH AND TELEPHONE CORPORATION, Tokyo (JP)

(72) Inventors: Hosana KAMIYAMA, Tokyo (JP); Atsushi ANDO, Tokyo (JP); Satoshi KOBASHIKAWA, Tokyo (JP)

(73) Assignee: NIPPON TELEGRAPH AND TELEPHONE CORPORATION, Tokyo (JP)

(21) Appl. No.: 17/630,855

(22) PCT Filed: Jul. 29, 2019
(86) PCT No.: PCT/JP2019/029666

§ 371 Date: Jan. 27, 2022

(51) Int. Cl. G10L 25/51; G10L 25/24; G10L 25/75; G10L 25/90

(52) U.S. Cl. CPC G10L 25/51; G10L 25/24; G10L 25/75; G10L 25/90

(57) ABSTRACT

An impression estimation technique without the need of voice recognition is provided. An impression estimation device includes an estimation unit configured to estimate an impression of a voice signal s by defining p₁<p₂ and using a first feature amount obtained based on a first analysis time length p₁ for the voice signal s and a second feature amount obtained based on a second analysis time length p₂ for the voice signal s. A learning device includes a learning unit configured to learn an estimation model which estimates the impression of the voice signal by defining p₁<p₂ and using a first feature amount for learning obtained based on the first analysis time length p₁ for a voice signal for learning s_{L}, a second feature amount for learning obtained based on the second analysis time length p₂ for the voice signal for learning s_{L}, and an impression label imparted to the voice signal for learning s_{L}.

### TECHNICAL FIELD

The present invention relates to an impression estimation technique of estimating an impression that a voice signal gives to a listener.

### BACKGROUND ART

An impression estimation technique capable of estimating an impression of an emergency degree or the like of a person making a phone call in an answering machine message or the like is needed. For example, when the impression of the emergency degree can be estimated using the impression estimation technique, a user can select an answering machine message with a high emergency degree without actually listening to the answering machine message.

As the impression estimation technique, Non-Patent Literature 1 is known. In Non-Patent Literature 1, an impression is estimated from vocal tract feature amounts such as MFCC (Mel-Frequency Cepstrum Coefficients) or PNCC (Power Normalized Cepstral Coefficients) and metrical features regarding a pitch and intensity of voice. In addition, in Non-Patent Literature 2, an impression is estimated using an average speech speed as a feature amount.

### CITATION LIST

### Non-Patent Literature

Non-Patent Literature 1: E. Principi et al., “Acoustic template-matching for automatic emergency state detection: An ELM based algorithm”, Neurocomputing, vol. 52, No. 3, p. 1185-1194, 2011.

Non-Patent Literature 2: Inanogliu et al., “Emotive Alert: HMM-Based Emotion Detection In Voicemail Message”, IUI 05, 2005.

### SUMMARY OF THE INVENTION

### Technical Problem

An impression is estimated using speech content or the like in the prior art, however, in a case where an estimated result depends on the speech content or a speech language, voice recognition is needed.

There is a case where a rhythm of speech is different since the impression is different depending on the impression of an estimation object. For example, when the estimation object is the impression of an emergency degree, the rhythm of the speech in the case where the emergency degree is high and the rhythm of the speech in the case where the emergency degree is low are different. Therefore, a method of estimating the impression using the rhythm of the speech is possible, however, the speech speed of voice is needed at the time. Here, in order to obtain the speech speed, the voice recognition is needed.

However, since the voice recognition often includes recognition errors, an impression estimation technique which does not require the voice recognition is needed.

An object of the present invention is to provide an impression estimation technique which does not require voice recognition.

### Means for Solving the Problem

In order to solve the problem described above, according to an aspect of the present invention, an impression estimation device includes an estimation unit configured to estimate an impression of a voice signal s by defining p₁<p₂ and using a first feature amount obtained based on a first analysis time length p₁ for the voice signal s and a second feature amount obtained based on a second analysis time length p₂ for the voice signal s.

In order to solve the problem described above, according to another aspect of the present invention, a learning device includes a learning unit configured to learn an estimation model which estimates the impression of the voice signal by defining p₁<p₂ and using a first feature amount for learning obtained based on a first analysis time length p₁ for a voice signal for learning s_{L}, a second feature amount for learning obtained based on a second analysis time length p₂ for the voice signal for learning s_{L}, and an impression label imparted to the voice signal for learning s_{L}.

### Effects of the Invention

According to the present invention, an effect of being capable of estimating an impression of speech without requiring voice recognition is accomplished.

### BRIEF DESCRIPTION OF DRAWINGS

FIG. 1 is a functional block diagram of an impression estimation device relating to a first embodiment.

FIG. 2 is a diagram illustrating an example of a processing flow of the impression estimation device relating to the first embodiment.

FIG. 3 is a diagram illustrating an example of a feature amount F₁(i).

FIG. 4 is a diagram illustrating a transition example of a second feature amount for which an analysis window is made long.

FIG. 5 is a functional block diagram of a learning device relating to the first embodiment.

FIG. 6 is a diagram illustrating an example of a processing flow of the learning device relating to the first embodiment.

FIG. 7 is a functional block diagram of the impression estimation device relating to a second embodiment.

FIG. 8 is a diagram illustrating an example of a processing flow of the impression estimation device relating to the second embodiment.

FIG. 9 is a functional block diagram of the learning device relating to the second embodiment.

FIG. 10 is a diagram illustrating an example of a processing flow of the learning device relating to the second embodiment.

FIG. 11 is a diagram illustrating an experimental result.

FIG. 12 is a diagram illustrating a configuration example of a computer which functions as the impression estimation device or the learning device.

### DESCRIPTION OF EMBODIMENTS

Hereinafter, the embodiments of the present invention will be described. Note that, on the drawings used for the description below, same signs are noted for configuration units having the same function and steps of performing same processing, and redundant description is omitted. In the description below, the processing performed in respective element units of vectors or matrixes is applied to all elements of the vectors and the matrixes unless otherwise specified.

<Point of First Embodiment>

In the present embodiment, by using an analysis window of a long analysis time length, an overall fluctuation of voice is captured. Thus, a rhythm of the voice is extracted and an impression is estimated without using voice recognition.

### First Embodiment

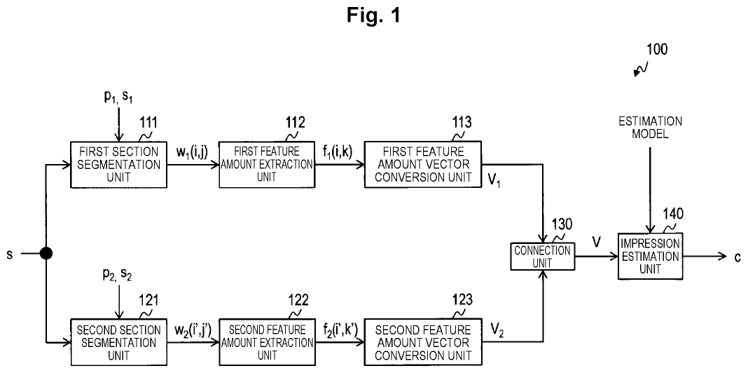

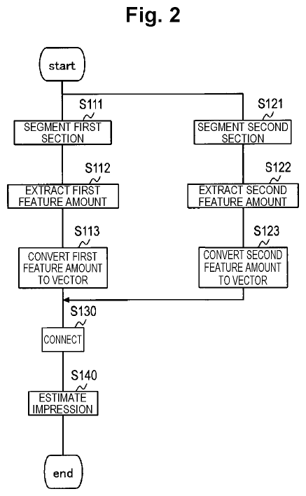

FIG. 1 illustrates a functional block diagram of an impression estimation device relating to the first embodiment, and FIG. 2 illustrates the processing flow.

An impression estimation device 100 includes a first section segmentation unit 111, a first feature amount extraction unit 112, a first feature amount vector conversion unit 113, a second section segmentation unit 121, a second feature amount extraction unit 122, a second feature amount vector conversion unit 123, a connection unit 130, and an impression estimation unit 140.

The impression estimation device 100 receives a voice signal s=[s(1), s(2), . . . , s(t), . . . , s(T)] as input, estimates the impression of the voice signal s, and outputs an estimated value c. In the present embodiment, the impression of an estimation object is defined as an emergency degree, and an emergency degree label which takes c=1 when it is estimated that the impression of the voice signal s is emergency and takes c=2 when it is estimated that the impression of the voice signal s is non-emergency is used as the estimated value c. Note that T is a total sample number of the voice signal s of the estimation object, and s(t) (t=1, 2, . . . , T) is a t-th sample included in the voice signal s of the estimation object.

The impression estimation device and a learning device are special devices configured by reading a special program in a known or exclusive computer including a central processing unit (CPU: Central Processing Unit) and a main storage (RAM: Random Access Memory) or the like, for example. The impression estimation device and the learning device execute each processing under control of the central processing unit. Data inputted to the impression estimation device and the learning device and data obtained in each processing are stored in the main storage for example, and the data stored in the main storage is read out to the central processing unit as needed and utilized in other processings. Respective processing units of the impression estimation device and the learning device may be at least partially configured by hardware such as an integrated circuit. Respective storage units included in the impression estimation device and the learning device can be configured by the main storage such as a RAM (Random Access Memory) or middleware such as a relational database or a key-value store, for example. The respective storage units are not always needed to be provided inside the impression estimation device and the learning device, and may be configured by an auxiliary storage configured by a semiconductor memory device such as a hard disk, an optical disk or a flash memory, and provided outside the impression estimation device and the learning device.

Hereinafter, the respective units will be described.

<First Section Segmentation Unit 111 and Second Section Segmentation Unit 121>

The first section segmentation unit 111 receives the voice signal s=[s(1), s(2), . . . , s(T)] as the input, uses analysis time length parameters p₁ and s₁, defines an analysis time length (analysis window width) as p₁ and a shift width as s₁, segments an analysis section w₁(i,j) from the voice signal s (S111), and outputs it. The analysis section w₁(i,j) can be expressed as follows for example.

$${w}_{1} ( i , j ) = s ( {s}_{1} * i + j ) ( 0 \leq i \leq [ \frac{( T - {s}_{1} )}{{s}_{1}} ] = {I}_{1} , 1 \leq j \leq {p}_{1} ) \qquad [ Math . 1 ]$$

Provided that i is a frame number and j is a sample number within the frame number i. I₁ is a total number of analysis sections when segmenting the voice signal of the estimation object by the analysis time length p₁ and the shift width s₁. The analysis section w₁(i,j) may be multiplied with a window function of a Hamming window or the like.

The second section segmentation unit 121 receives the voice signal s=[s(1), s(2), . . . , s(T)] as the input, uses analysis time length parameters p₂ and s₂, defines the analysis time length (analysis window width) as p₂ and the shift width as s₂, segments an analysis section w₂(i′,j′) from the voice signal s (S121), and outputs it. Provided that it is

$${w}_{2} ( {i}^{′} , {j}^{′} ) = s ( {s}_{2} * {i}^{′} + {j}^{′} ) 0 \leq {i}^{′} \leq [ \frac{( T - {s}_{2} )}{{s}_{2}} ] = {I}_{2} , 1 \leq {j}^{′} \leq {p}_{2} \qquad [ Math . 2 ]$$

i′ is the frame number and j′ is the sample number within the frame number i′. I₂ is the total number of the analysis sections when segmenting the voice signal of the estimation object by the analysis time length p₂ and the shift width s₂.

Here, as the analysis window width p₂, a value to be p₁≠p₂ is set. When p₁<p₂ holds, the larger analysis window width p₂ makes it easier to analyze a rhythm change of sound since analysis time is long. For example, in the case where a sampling frequency of voice is 16000 Hz, parameters can be set as p₁=400(0.025 second), s₁=160 (0.010 second), p₂=16000 (1 second) and s₂=1600 (0.100 second).

<First Feature Amount Extraction Unit 112 and Second Feature Amount Extraction Unit 122>

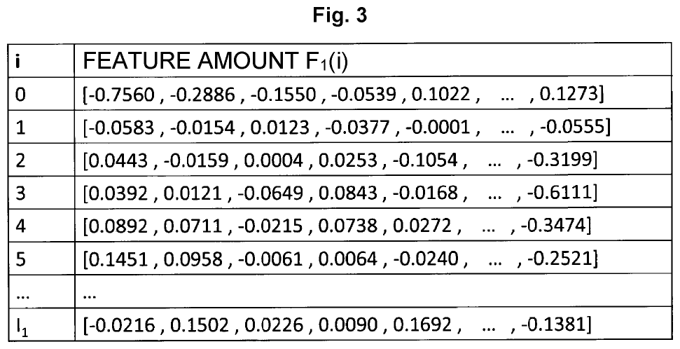

The first feature amount extraction unit 112 receives the analysis section w₁(i,j) as the input, extracts a feature amount f₁(i,k) from the analysis section w₁(i,j) (S112), and outputs it. Provided that k is a dimensional number of the feature amount, and is k=1, 2, . . . , K₁. An example of a feature amount F₁(i)=[f₁(i,1), f₁(i,2), . . . , f₁(i,k), . . . , f₁(i,K₁)] is illustrated in FIG. 3. As the feature amount, MFCC which expresses a vocal tract characteristic of the voice, F0 extraction which expresses the pitch of the voice and power which expresses volume of the voice or the like are possible. The feature amounts may be extracted using a known method. In the example, the first feature amount extraction unit 112 extracts the feature amount regarding at least either of the vocal tract and the pitch of the voice.

The second feature amount extraction unit 122 receives the analysis section w₂(i′,j′) as the input, extracts a feature amount f₂(i′,k′) from the analysis section w₂(i′,j′) (S122), and outputs it. Provided that k′=1, 2, . . . , K₂. When p₁<p₂ holds, as the feature amount, the feature amount which captures the overall change such as EMS (Envelope Modulation Spectra) (Reference Literature 1) is possible.

(Reference Literature 1) J. M. Liss et al., “Discriminating Dysarthria Type From Envelope Modulation Spectra”, J Speech Lang Hear Res. A, 2010.

In the example, the second feature amount extraction unit 122 extracts the feature amount regarding the rhythm of the voice signal.

In other words, p₂ of the second section segmentation unit 121 is set so as to extract the feature amount regarding the rhythm of the voice signal in the second feature amount extraction unit 122, and p₁ of the first section segmentation unit 111 is set so as to extract the feature amount regarding at least either of the vocal tract and the pitch of the voice in the first feature amount extraction unit 112.

<First feature amount vector conversion unit 113 and second feature amount vector conversion unit 123>

The first feature amount vector conversion unit 113 receives the feature amount f₁(i,k) as the input, converts the feature amount f₁(i,k) to a feature amount vector V₁ which contributes to determination of the emergency degree (S113), and outputs it. Conversion to the feature amount vector is performed by a known technique such as acquisition of statistics of the mean and variance or the like of a feature amount series or a method of converting time sequential data to the vector by a neural network (LSTM (Long short-term memory) or the like).

For example, in the case of taking the mean and the variance, vectorization is possible as follows.

$${V}_{1} = [ {v}_{1} ( 1 ) , {v}_{1} ( 2 ) , … , {v}_{1} ( {K}_{1} ) ] {v}_{1} ( k ) = [ mean ( {F}_{1} ( k ) ) , var ( {F}_{1} ( k ) ) ] {F}_{1} ( k ) = [ {f}_{1} ( 1 , k ) , {f}_{1} ( 2 , k ) , … , {f}_{1} ( {I}_{1} , k ) ] mean ( {F}_{1} ( k ) ) = \frac{{\sum }_{i = 1}^{{I}_{1}} {f}_{1} ( i , k )}{{I}_{1}} var ( {F}_{1} ( k ) ) = \frac{{\sum }_{i = 1}^{{I}_{1}} {( {f}_{1} ( i , k ) - mean ( {F}_{1} ( k ) ) )}^{2}}{{I}_{1}} \qquad [ Math . 3 ]$$

The second feature amount vector conversion unit 123 similarly receives the feature amount f₂(i′,k′) as the input, converts the feature amount f₂(i′,k′) to a feature amount vector V₂=[v₂(1), v₂ (2), . . . , v₂ (K₂)] which contributes to the determination of the emergency degree (S123), and outputs it. For a conversion method, the method similar to that of the first feature amount vector conversion unit 113 may be used or a different method may be used.

<Connection Unit 130>

The connection unit 130 receives the feature vectors V₁ and V₂ as the input, connects the feature amount vectors V₁ and V₂, obtains a connected vector V=[V₁,V₂] to be used for emergency degree determination (S130), and outputs it.

Other than simple vector connection, the connection unit 130 can perform connection by addition or the like when the dimensional numbers K₁ and K₂ are the same.

<Impression Estimation Unit 140>

The impression estimation unit 140 receives the connected vector V as the input, estimates whether the voice signal s is the emergency or the non-emergency from the connected vector V (S140), and outputs the estimated value c (emergency label). A class of the emergency and the non-emergency is estimated by a general machine learning method of SVM (Support Vector Machine), Random Forest or the neural network or the like. While an estimation model needs to be learned beforehand upon estimation, learning data is prepared and learning is performed by a general method. The learning device which learns the estimation model will be described later. The estimation model is a model which inputs the connected vector V and outputs the estimated value of the impression of the voice signal. For example, the impression of the estimation object is the emergency or the non-emergency. That is, the impression estimation unit 140 turns the connected vector V to the input of the estimation model and obtains the estimated value which is the output of the estimation model.

Compared to the prior art, by capturing a feature regarding the rhythm, estimation accuracy of the impression is improved.

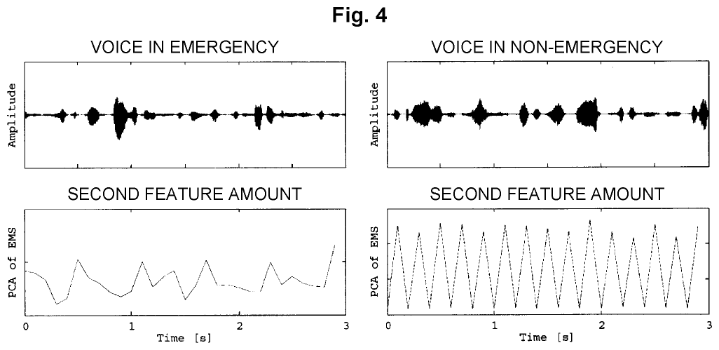

In the prior art, an average speech speed of a call is obtained by the voice recognition (see Non-Patent Literature 2). However, since the voice with the high emergency degree is in a speech style of quickly telling content while thinking, the fluctuation of the speech speed becomes large and an irregular rhythm is generated. Transition of a second feature amount (EMS) for which the analysis window is made long is illustrated in FIG. 4. FIG. 4 is a first main component when main component analysis is performed for the EMS. While the voice in the emergency irregularly changes, the voice in the non-emergency stably vibrates. By using the long-time analysis window in this way, it is recognized that a difference in the rhythm appears in the second feature amount.

The impression can be estimated without obtaining the speech speed and a voice recognition result by obtaining the rhythm of the speech as the feature amount in the long-time analysis section of the present embodiment, in addition to the feature that the pitch of the voice becomes high and the feature that the intensity becomes high in the case of the voice in the emergency, that have been used in the prior art.

<Learning Device 200>

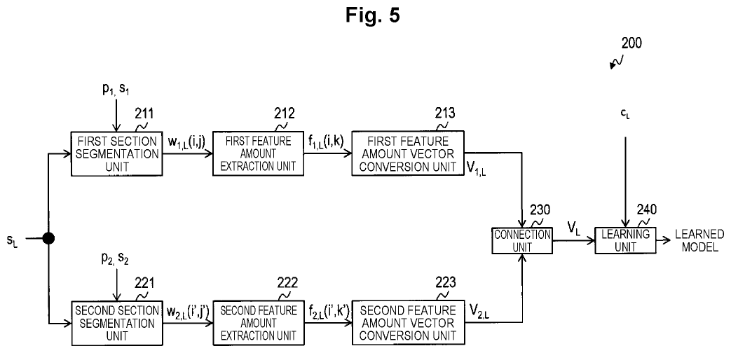

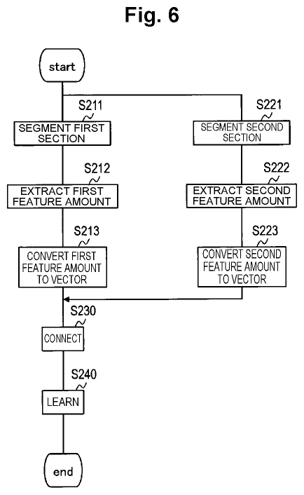

FIG. 5 illustrates a functional block diagram of the learning device relating to the first embodiment, and FIG. 6 illustrates the processing flow.

The learning device 200 includes a first section segmentation unit 211, a first feature amount extraction unit 212, a first feature amount vector conversion unit 213, a second section segmentation unit 221, a second feature amount extraction unit 222, a second feature amount vector conversion unit 223, a connection unit 230, and a learning unit 240.

The learning device 200 receives a voice signal for learning s_{L} and an impression label for learning c_{L} as the input, learns the estimation model which estimates the impression of the voice signal, and outputs the learned estimation model. The impression label c_{L} may be manually imparted before learning or may be obtained beforehand from a voice signal for learning s_{L} by some means and imparted.

The first section segmentation unit 211, the first feature amount extraction unit 212, the first feature amount vector conversion unit 213, the second section segmentation unit 221, the second feature amount extraction unit 222, the second feature amount vector conversion unit 223 and the connection unit 230 perform processing S211, S212, S213, S221, S222, S223 and S230 similar to the processing S111, S112, S113, S121, S122, S123 and S130 of the first section segmentation unit 111, the first feature amount extraction unit 112, the first feature amount vector conversion unit 113, the second section segmentation unit 121, the second feature amount extraction unit 122, the second feature amount vector conversion unit 123 and the connection unit 130, respectively. However, the processing is performed to the voice signal for learning s_{L} and information originated from the voice signal for learning s_{L}, instead of the voice signal s and information originated from the voice signal s.

<Learning Unit 240>

The learning unit 240 receives a connected vector V_{L} and the impression label c_{L} as the input, learns the estimation model which estimates the impression of the voice signal (S240), and outputs the learned estimation model. Note that the estimation model may be learned by the general machine learning method of the SVM (Support Vector Machine), the Random Forest or the neural network or the like.

<Effect>

By the above configuration, the impression can be estimated with free speech content without the need of the voice recognition.

<Modification>

The first feature amount vector conversion unit 113, the second feature amount vector conversion unit 123, the connection unit 130 and the impression estimation unit 140 of the present embodiment may be expressed by one neural network. The entire neural network may be referred to as an estimation unit. In addition, the first feature amount vector conversion unit 113, the second feature amount vector conversion unit 123, the connection unit 130 and the impression estimation unit 140 of the present embodiment may be referred to as the estimation unit altogether. In either case, the estimation unit estimates the impression of the voice signal s using the first feature amount f₁(i,k) obtained based on the analysis time length p₁ for the voice signal s and the second feature amount f₂(i′,k′) obtained based on the analysis time length p₂ for the voice signal s.

Similarly, the first feature amount vector conversion unit 213, the second feature amount vector conversion unit 223, the connection unit 230 and the learning unit 240 may be expressed by one neural network to perform learning. The entire neural network may be referred to as the learning unit. In addition, the first feature amount vector conversion unit 213, the second feature amount vector conversion unit 223, the connection unit 230 and the learning unit 240 of the present embodiment may be referred to as the learning unit altogether. In either case, the learning unit learns the estimation model which estimates the impression of the voice signal using the first feature amount for learning f_{1,L}(i,k) obtained based on the first analysis time length p₁ for the voice signal for learning s_{L}, the second feature amount for learning f_{2,L}(i′,k′) obtained based on the second analysis time length p₂ for the voice signal for learning s_{L}, and the impression label c_{L} imparted to the voice signal for learning s_{L}.

Further, while the impression of the emergency degree is estimated in the present embodiment, even the impression of something other than the emergency degree can be the object of the estimation as long as it is the impression in which the rhythm is changed by the difference of the impression.

### Second Embodiment

The description will be given with a focus on a part different from the first embodiment.

In the present embodiment, the emergency degree is estimated using long-time feature amount statistics.

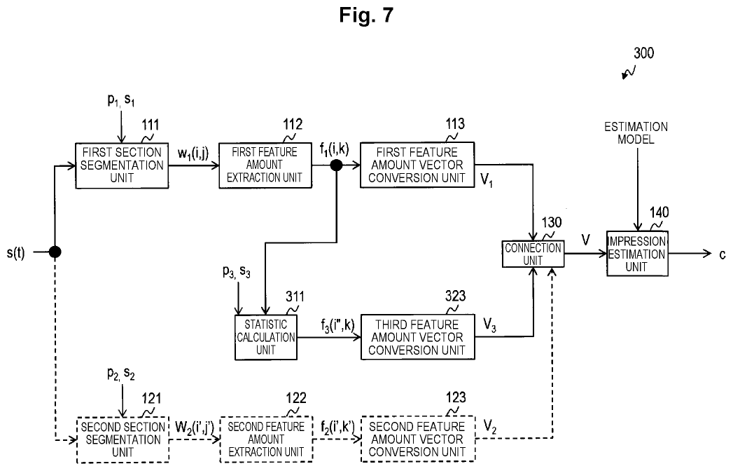

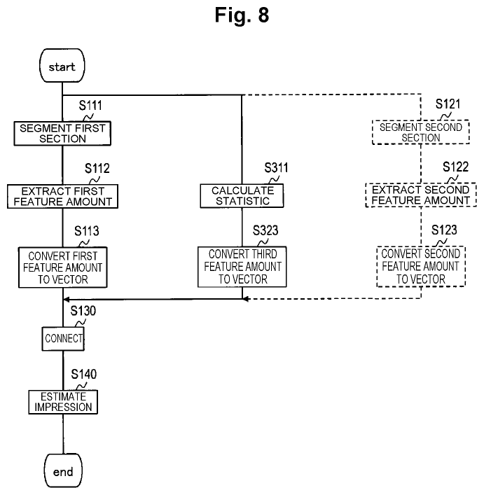

FIG. 7 illustrates a functional block diagram of the impression estimation device relating to the second embodiment, and FIG. 8 illustrates the processing flow.

An impression estimation device 300 includes the first section segmentation unit 111, the first feature amount extraction unit 112, the first feature amount vector conversion unit 113, a statistic calculation unit 311, a third feature amount vector conversion unit 323, the connection unit 130 and the impression estimation unit 140.

In the present embodiment, the second section segmentation unit 121, the second feature amount extraction unit 122 and the second feature amount vector conversion unit 123 are removed from the impression estimation device 100, and the statistic calculation unit 311 and the third feature amount vector conversion unit 323 are added. The other configuration is similar to the first embodiment.

<Statistic Calculation Unit 311>

The statistic calculation unit 311 receives the feature amount f₁(i,k) as the input, calculates a statistic using analysis time length parameters p₃ and s₃ (S311), and obtains and outputs a feature amount f₃(i″,k)=[f₃(i″,k,1), f₃(i″,k,2), . . . , f₃(i″,k,k″), . . . , f₃(i″,k, K₃)]. It is k″=1, 2, . . . , K₃ and 0≤i″≤I₃, i″ is an index of the statistic, p₃ is a sample number when calculating the statistic from the feature amount f₁(i,k), and s₃ is a shift width when calculating the statistic from the feature amount f₁(i,k). I₃ is the total number of calculating the statistic. A value to be p₃>2 is set. When p₃>2 holds, p₃ pieces of the feature amount f₁(i,k) are used, the analysis time becomes s₁×(p₃−1)+p₁ and longer than p₁, and it becomes easy to analyze the rhythm change of the sound. Here, the analysis time length s₁×(p₃−1)+p₁ corresponds to the analysis time p₂ in the first embodiment. The statistic calculation unit 311 performs the analysis of the long-time window width and conversion to the feature amount regarding the rhythm similar to the first embodiment by calculating the statistic for the window width s₁×(p₃−1)+p₁ of a fixed section based on the feature amount f₁(i,k) obtained by the analysis of a short-time window width. For the statistic, for example, a mean ‘mean’, a standard deviation ‘std’, a maximum value ‘max’, a kurtosis ‘kurtosis’, skewness ‘skewness’ and a mean absolute deviation ‘mad’ can be obtained, and a computation expression is as follows, respectively.

f₃(i″,k)=[mean(i″,F₁(k)),std(i″,F₁(k)),max(i″,F₁(k)),kurtosis(i″,F₁(k)),skewness(i″,F₁(k)),mad(i″,F₁(k))]

Note that the statistic becomes the feature amount indicating the degree of the change of the sound in the respective sections, when MFCC is used for example, and the change degree becomes the feature amount related to the rhythm.

$$mean ( {i}^{″} , {F}_{1} ( k ) ) = \frac{{\sum }_{i = 1}^{{p}_{3}} {f}_{1} ( {s}_{{3}^{*}} {i}^{″} + i , k )}{{p}_{3}} std ( {i}^{″} , {F}_{1} ( k ) ) = \sqrt{\frac{{\sum }_{i = 1}^{{p}_{3}} {( {f}_{1} ( {s}_{3} * {i}^{″} + i , k ) - mean ( {i}^{″} , {F}_{1} ( k ) ) )}^{2}}{{p}_{3} - 1}} max ( {i}^{″} , {F}_{1} ( k ) ) = {max}_{1 \leq i \leq {p}_{3}} {f}_{1} ( {s}_{3} * {i}^{″} + i , k ) kurtosis = ( {i}^{″} , {F}_{1} ( k ) ) = \frac{{p}_{3} ( {p}_{3} + 1 ) {\sum }_{i = 1}^{{p}_{3}} {( {f}_{1} ( {s}_{3} * {i}^{″} + i , k ) - mean ( {i}^{″} , {F}_{1} ( k ) ) )}^{4}}{( {p}_{3} - 1 ) * ( {p}_{3} - 2 ) * ( {p}_{3} - 3 ) * {( std ( {i}^{″} , k ) )}^{4}} skewness ( {i}^{″} , {F}_{1} ( k ) ) = \frac{{p}_{3} {\sum }_{i = 1}^{{p}_{3}} {( {f}_{1} ( {s}_{3} * {i}^{″} + i , k ) - mean ( {i}^{″} , {F}_{1} ( k ) ) )}^{3}}{( {p}_{3} - 1 ) * ( {p}_{3} - 2 ) * {( std ( {i}^{″} , k ) )}^{3}} ( i {F}_{1} ( k ) ) mad ( {i}^{″} , {F}_{1} ( k ) ) = \frac{{\sum }_{i = 1}^{{p}_{3}} \vert ( {f}_{1} ( {s}_{3} * {i}^{″} + i , k ) - mean ( {i}^{″} , {F}_{1} ( k ) ) \vert}{{p}_{3}} \qquad [ Math . 4 ]$$

<Third Feature Amount Vector Conversion Unit 323>

The third feature amount vector conversion unit 323 receives the feature amount f₃(i″,k′) as the input, converts the feature amount f₃(i″,k′) to a feature amount vector V₃=[v₃(1), v₃(2), . . . , v₃(K₁)] which contributes to the determination of the emergency degree (S323), and outputs it. By the method similar to the first embodiment, the vectorization is made possible. For example, in the case of taking the mean and the variance, the vectorization is possible as follows.

$${V}_{3} = [ {v}_{3} ( 1 ) , {v}_{3} ( 2 ) , … , {v}_{3} ( {K}_{1} ) ] \\ {v}_{3} ( k ) = [ mean ( {F}_{3} ( k ) ) , var ( {F}_{3} ( k ) ) ] \\ {F}_{3} ( k ) = [ {f}_{3} ( 1 , k ) , {f}_{3} ( 2 , k ) , … , {f}_{3} ( {I}_{3} , k ) ] \\ mean ( {F}_{3} ( k ) ) = [ mean ( {f}_{3} ( k , 1 ) ) , mean ( {f}_{3} ( k , 2 ) ) , … , mean ( {f}_{3} ( k , {K}_{3} ) ) ] \\ {f}_{3} ( {i}^{″} , k ) = [ {f}_{3} ( {i}^{″} , k , 1 ) , {f}_{3} ( {i}^{″} , k , 2 ) , … , {f}_{3} ( {i}^{″} , k , {K}_{3} ) ] \\ mean ( {f}_{3} ( k , {k}^{″} ) ) = \frac{{\sum }_{{i}^{″} = 1}^{{I}_{3}} ( {f}_{3} ( {i}^{″} , k , {k}^{″} ) )}{{I}_{3}} \\ var ( {F}_{3} ( k ) ) = [ var ( {f}_{3} ( k , 1 ) ) , var ( {f}_{3} ( k , 2 ) ) , … , var ( {f}_{3} ( k , {K}_{3} ) , ) ] \\ var ( {f}_{3} ( k , {k}^{″} ) ) = \frac{{\sum }_{{i}^{″} = 1}^{{I}_{3}} {( {f}_{3} ( i , k , {k}^{″} ) - mean ( {f}_{3} ( k , {k}^{″} ) ) )}^{2}}{{I}_{3}} \qquad [ Math . 5 ]$$

Note that the connection unit 130 performs the processing S130 by using the feature amount vector V₃ instead of the feature amount vector V₂.

<Learning Device 400>

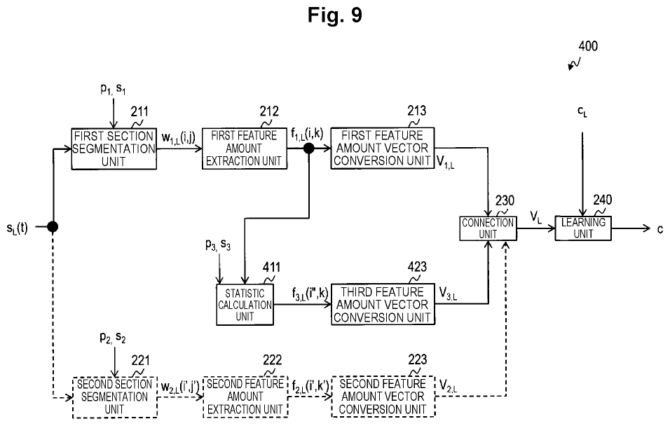

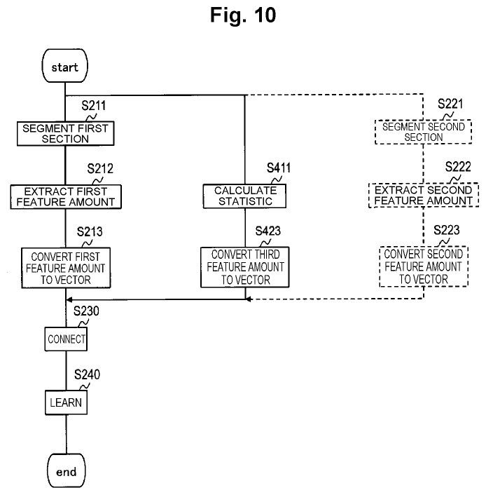

FIG. 9 illustrates a functional block diagram of the learning device relating to the second embodiment, and FIG. 10 illustrates the processing flow.

The learning device 400 includes the first section segmentation unit 211, the first feature amount extraction unit 212, the first feature amount vector conversion unit 213, a statistic calculation unit 411, a third feature amount vector conversion unit 423, the connection unit 230 and the learning unit 240.

The learning device 400 receives a voice signal for learning s_{L}(t) and the impression label for learning c_{L} as the input, learns the estimation model which estimates the impression of the voice signal, and outputs the learned estimation model.

The statistic calculation unit 411 and the third feature amount vector conversion unit 423 perform processing S411 and S423 similar to the processing S311 and S323 of the statistic calculation unit 311 and the third feature amount vector conversion unit 323, respectively. However, the processing is performed to the voice signal for learning s_{L}(t) and information originated from the voice signal for learning s_{L}(t), instead of the voice signal s (t) and information originated from the voice signal s (t). The other configuration is as described in the first embodiment. Note that the connection unit 230 performs the processing S230 using the feature amount vector V_{3,L} instead of the feature amount vector V_{2,L}.

<Effect>

By attaining such a configuration, the effect similar to that of the first embodiment can be obtained.

<Modification 1>

The first embodiment and the second embodiment may be combined.

As illustrated with broken lines in FIG. 7, the impression estimation device 300 includes the second section segmentation unit 121, the second feature amount extraction unit 122 and the second feature amount vector conversion unit 123 in addition to the configuration of the second embodiment.

As illustrated with broken lines in FIG. 8, the impression estimation device 300 performs S121, S122 and S123 in addition to the processing in the second embodiment.

The connection unit 130 receives the feature amount vectors V₁, V₂ and V₃ as the input, connects the feature amount vectors V₁, V₂ and V₃, obtains a connected vector V=[V₁,V₂,V₃] to be used for the emergency degree determination (S130), and outputs it.

Similarly, as illustrated in FIG. 9, the learning device 400 includes the second section segmentation unit 221, the second feature amount extraction unit 222 and the second feature amount vector conversion unit 223 in addition to the configuration of the second embodiment.

In addition, as illustrated in FIG. 10, the learning device 400 performs S221, S222 and S223 in addition to the processing in the second embodiment.

The connection unit 230 receives the feature amount vectors V_{1,L}, V_{2,L} and V_{3,L} as the input, connects the feature amount vectors V_{1,L}, V_{2,L} and V_{3,L}, obtains a connected vector V_{L}=[V_{1,L},V_{2,L},V_{3,L}] to be used for the emergency degree determination (S230), and outputs it.

<Effect>

By attaining such a configuration, an estimated result with higher accuracy than that of the second embodiment can be obtained.

<Experimental Result>

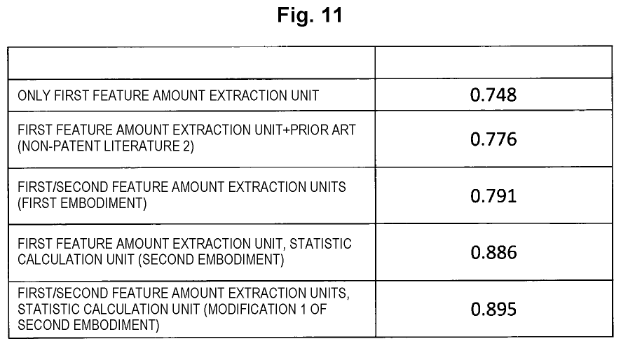

FIG. 11 illustrates results in the case with no second feature amount extraction unit, in the case of the first embodiment, in the case of the second embodiment and in the case of the modification 1 of the second embodiment.

In this way, it is recognized that the effect of the long-time feature amount by the first embodiment and the second embodiment is greater than that in the case of only the first feature amount.

<Modification 2>

Further, the first embodiment and the second embodiment may be used separately according to a language.

For example, the impression estimation device receives language information indicating a kind of the language as the input, estimates the impression in the first embodiment at the time of a certain language A, and estimates the impression in the second embodiment at the time of another language B. Note that the estimation accuracy of which embodiment is higher is determined beforehand for each language, and the embodiment with the higher accuracy is selected according to the language information at the time of the estimation. The language information may be estimated from the voice signal s (t) or may be inputted by a user.

<Other Modifications>

The present invention is not limited to the embodiments and modifications described above. For example, the various kinds of processing described above are not only time-sequentially executed according to the description but may also be executed in parallel or individually according to throughput of the device which executes the processing or needs. In addition, appropriate changes are possible without departing from the purpose of the present invention.

<Program and Recording Medium>

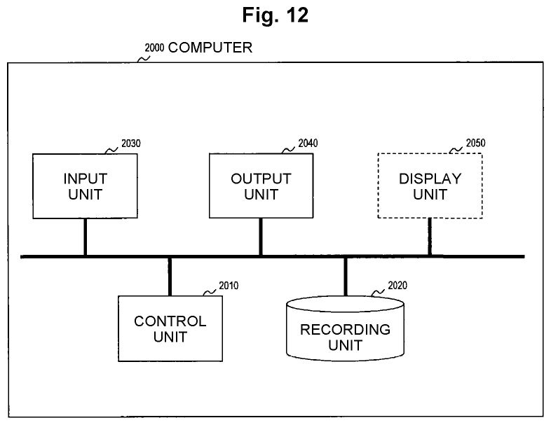

The various kinds of processing described above can be executed by making a recording unit 2020 of a computer illustrated in FIG. 12 read the program of executing respective steps of the method described above and making a control unit 2010, an input unit 2030 and an output unit 2040 or the like perform operations.

The program in which the processing content is described can be recorded in a computer-readable recording medium. Examples of the computer-readable recording medium are a magnetic recording device, an optical disk, a magneto-optical recording medium and a semiconductor memory or the like.

In addition, the program is distributed by selling, assigning or lending a portable recording medium such as a DVD or a CD-ROM in which the program is recorded, for example. Further, the program may be distributed by storing the program in a storage of a server computer and transferring the program from the server computer to another computer via a network.

The computer executing such a program tentatively stores the program recorded in the portable recording medium or the program transferred from the server computer in its own storage first, for example. Then, when executing the processing, the computer reads the program stored in its own recording medium, and executes the processing according to the read program. In addition, as another execution form of the program, the computer may directly read the program from the portable recording medium and execute the processing according to the program, and further, every time the program is transferred from the server computer to the computer, the processing according to the received program may be successively executed. In addition, the processing described above may be executed by a so-called ASP (Application Service Provider) type service which achieves a processing function only by the execution instruction and result acquisition without transferring the program from the server computer to the computer. Note that the program in the present embodiment includes the information which is provided for the processing by an electronic computer and which is equivalent to the program (data which is not a direct command to the computer but has a property of stipulating the processing of the computer or the like).

In addition, while the present device is configured by executing a predetermined program on the computer in the present embodiment, at least part of the processing content may be achieved in a hardware manner.

1. An impression estimation device comprising circuit configured to execute a method comprising:
estimating an impression of a voice signal s by defining p₁<p₂ and using a first feature amount obtained based on a first analysis time length p₁ for the voice signal s and a second feature amount obtained based on a second analysis time length p₂ for the voice signal s.

2. The impression estimation device according to claim 1,
wherein the first feature amount is a feature amount regarding at least either of a vocal tract and a voice pitch and the second feature amount is a feature amount regarding a rhythm of voice.

3. The impression estimation device according to claim 1,
wherein the second feature amount is a statistic calculated for the second analysis time length based on the first feature amount.

4. A learning device comprising circuit configured to execute a method comprising:
learning an estimation model which estimates an impression of a voice signal by defining p₁<p₂ and using a first feature amount for learning obtained based on a first analysis time length p₁ for a voice signal for learning s_{L}, a second feature amount for learning obtained based on a second analysis time length p₂ for the voice signal for learning s_{L}, and an impression label imparted to the voice signal for learning s_{L}.

5. (canceled)

6. A learning method comprising
learning an estimation model which estimates an impression of a voice signal by defining p₁<p₂ and using a first feature amount for learning obtained based on a first analysis time length p₁ for a voice signal for learning s_{L}, a second feature amount for learning obtained based on a second analysis time length p₂ for the voice signal for learning s_{L}, and an impression label imparted to the voice signal for learning s_{L}.

7. (canceled)

8. The impression estimation device according to claim 1, wherein the impression corresponds to emergency.

9. The impression estimation device according to claim 1, wherein the impression corresponds to non-emergency.

10. The impression estimation device according to claim 1, wherein the first feature amount indicates a vocal tract characteristic of a voice based on Mel-Frequency Cepstrum Coefficients.

11. The impression estimation device according to claim 1, wherein the estimating excludes recognizing speed of a voice associated with the voice signal s.

12. The learning device according to claim 4, wherein the first feature amount is a feature amount regarding at least either of a vocal tract and a voice pitch and the second feature amount is a feature amount regarding a rhythm of voice.

13. The learning device according to claim 4, wherein the second feature amount is a statistic calculated for the second analysis time length based on the first feature amount.

14. The learning device according to claim 4, wherein the impression corresponds to emergency.

15. The learning device according to claim 4, wherein the impression corresponds to non-emergency.

16. The learning device according to claim 4, wherein the first feature amount indicates a vocal tract characteristic of a voice based on Mel-Frequency Cepstrum Coefficients.

17. The learning device according to claim 4, wherein the learning an estimation model uses at least one of a Support Vector Machine, a Random Forest, or a neural network.

18. The learning method according to claim 6, wherein the first feature amount is a feature amount regarding at least either of a vocal tract and a voice pitch and the second feature amount is a feature amount regarding a rhythm of voice.

19. The learning method according to claim 6, wherein the second feature amount is a statistic calculated for the second analysis time length based on the first feature amount.

20. The learning method according to claim 6, wherein the impression corresponds to emergency.

21. The learning method according to claim 6, wherein the first feature amount indicates a vocal tract characteristic of a voice based on Mel-Frequency Cepstrum Coefficients.

22. The learning method according to claim 6, wherein the learning an estimation model uses at least one of a Support Vector Machine, a Random Forest, or a neural network.
